(19) United States
(12) Patent Application Publication
(10) Pub. No.: US 2013/0003811 A1
(43) Pub. Date: Jan. 3, 2013

(54) COMMUNICATION APPARATUS AND RECEPTION POWER MEASURING METHOD

(75) Inventors: Jun Kitakado, Yokohama-shi (JP); Masashi Iwami, Ogaki-shi (JP)

(73) Assignee: KYOCERA CORPORATION, Kyoto-shi, Kyoto (JP)

(21) Appl. No.: 13/635,637

(22) PCT Filed: Mar. 17, 2011
(86) PCT No.: PCT/JP2011/056374

§ 371 Date: Sep. 17, 2012

(30) Foreign Application Priority Data
Mar. 17, 2010 (JP) 2010-061581

(51) Int. Cl. H04B 17/00

(52) U.S. Cl. 375/224

(57) ABSTRACT

A communication apparatus includes: a quadrature detection unit 13 for performing a quadrature detection on a baseband OFDM signal and generating a complex OFDM signal; an FFT unit for performing a Fourier transform process on the complex OFDM signal and outputting a complex symbol with respect to each subcarrier; and a reception power calculation unit for obtaining a reception power of a reception signal based on the sum of squares of an in-phase signal and a quadrature signal of the complex symbol of the subcarrier outputted from the FFT unit. The reception power calculation unit includes a table indicating the relationship between the reception power and the sum of squares of the in-phase signal and the quadrature signal of the complex symbol, and obtains the reception power of the reception signal by using the table.

### TECHNICAL FIELD

The present invention relates to a reception power measurement technique.

### BACKGROUND ART

Conventionally, various techniques have been proposed for wireless communication. For example, Non-Patent Document 1 discloses a standard for a communication system called a next-generation PHS (Personal Handyphone System). In the next-generation PHS, each base station communicates with a plurality of communication terminals by a communication scheme using TDMA/TDD (Time Division Multiple Access/Time Division Duplexing). In the TDMA/TDD adopted in the next-generation PHS, a transmission period including four slots and a reception period including four slots alternately appear. In the communication scheme of the next-generation PHS, OFDMA (Orthogonal Frequency Division Multiple Access) is also used. In the OFDMA, an OFDM (Orthogonal Frequency Division Multiplexing) signal in which a plurality of orthogonal subcarriers are combined is used.

### PRIOR-ART DOCUMENTS

### Non-Patent Documents

Non-Patent Document 1: “OFDMA/TDMA TDD Broadband Wireless Access System (Next Generation PHS) ARIB STANDARD”, ARIB STD-T95 Version 1.3, Dec. 16, 2009, Association of Radio Industries and Businesses

### SUMMARY OF THE INVENTION

### Problems to be Solved by the Invention

In wireless communication with such an OFDM scheme, a reception power that indicates the reception signal strength of a signal transmitted from a communication partner can be measured by, for example, using an output of a special device to which the reception signal has been inputted. However, there is a limit to the safe operating range of this special device and thus, depending on the strength (electric field strength) of a received signal, the output of the special device may have a measurement error, which can deteriorate a reception power measurement accuracy.

The present invention is made in view of the above-described points, and an object of the present invention is to provide a technique capable of accurately measuring a reception power.

### Means for Solving the Problems

A communication apparatus according to the present invention includes: a quadrature detection unit for performing a quadrature detection on a reception signal that is an OFDM signal and generating a complex OFDM signal; a Fourier transform unit for performing a Fourier transform process on the complex OFDM signal and outputting a complex symbol with respect to each subcarrier; and a reception power acquisition unit for obtaining a reception power of the reception signal based on a sum of squares of an in-phase signal and a quadrature signal of the complex symbol of the subcarrier outputted from the Fourier transform unit, wherein the reception power acquisition unit includes a storage unit for storing a correspondence relationship between a reception power and a sum of squares of an in-phase signal and a quadrature signal of a complex symbol, and obtains the reception power of the reception signal by using the correspondence relationship.

In one aspect of the communication apparatus according to the present invention, the reception power acquisition unit obtains, on a slot basis, a first slot reception power of the reception signal based on the sum of squares of the in-phase signal and the quadrature signal of the complex symbol of the subcarrier outputted from the Fourier transform unit, and the communication apparatus further includes: a detection unit for detecting a signal level of the reception signal based on the reception signal in a time domain; a slot reception power acquisition unit for obtaining, on a slot basis, a second slot reception power of the reception signal based on the signal level of the reception signal; and a selection unit for selecting, in an alternative manner, either one of the first slot reception power and the second slot reception power as a slot reception power of the reception signal.

In one aspect of the communication apparatus according to the present invention, the correspondence relationship is obtained in advance by measuring a sum of squares of an in-phase signal and a quadrature signal of a subcarrier outputted from the Fourier transform unit as a result of inputting a signal having a known reception power to the communication apparatus.

In one aspect of the communication apparatus according to the present invention, the correspondence relationship is, in the form of a table, stored in the storage unit.

In one aspect of the communication apparatus according to the present invention, the communication apparatus further includes an A/D conversion unit for converting a signal in analog form into a signal in digital form, wherein: the complex OFDM signal inputted to the Fourier transform unit is a signal in the digital form; the selection unit selects, in an alternative manner, either one of the first slot reception power and the second slot reception power as the slot reception power of the reception signal, in accordance with a result of comparison between the second slot reception power and a predetermined value; and the predetermined value is a slot reception power in such a range that an output signal of the A/D conversion unit is not saturated.

In one aspect of the communication apparatus according to the present invention, in a case where the second slot reception power is higher than the predetermined value, the selection unit selects the second slot reception power as the slot reception power of the reception signal.

In one aspect of the communication apparatus according to the present invention, in a case where the second slot reception power is equal to or lower than the predetermined value, the selection unit selects the first slot reception power as the slot reception power of the reception signal.

In one aspect of the communication apparatus according to the present invention, based on the sum of squares of the in-phase signal and the quadrature signal of the complex symbol of the subcarrier outputted from the Fourier transform unit, the reception power acquisition unit obtains a reception power of a sub channel including said subcarrier.

A reception power measuring method according to the present invention includes the steps of a) performing a quadrature detection on a reception signal that is an OFDM signal and generating a complex OFDM signal; b) performing a Fourier transform process on the complex OFDM signal and outputting a complex symbol with respect to each subcarrier; and c) obtaining a reception power of the reception signal based on a sum of squares of an in-phase signal and a quadrature signal of a complex symbol of the subcarrier, wherein, in the step c), the reception power of the reception signal is obtained by using a correspondence relationship between a reception power and the sum of squares of an in-phase signal and a quadrature signal of a complex symbol, the correspondence relationship being stored in advance.

### Effect of the Invention

The present invention enables the reception power to be accurately measured.

These and other objects, features, aspects and advantages of the present invention will become more apparent from the following detailed description of the present invention when taken in conjunction with the accompanying drawings.

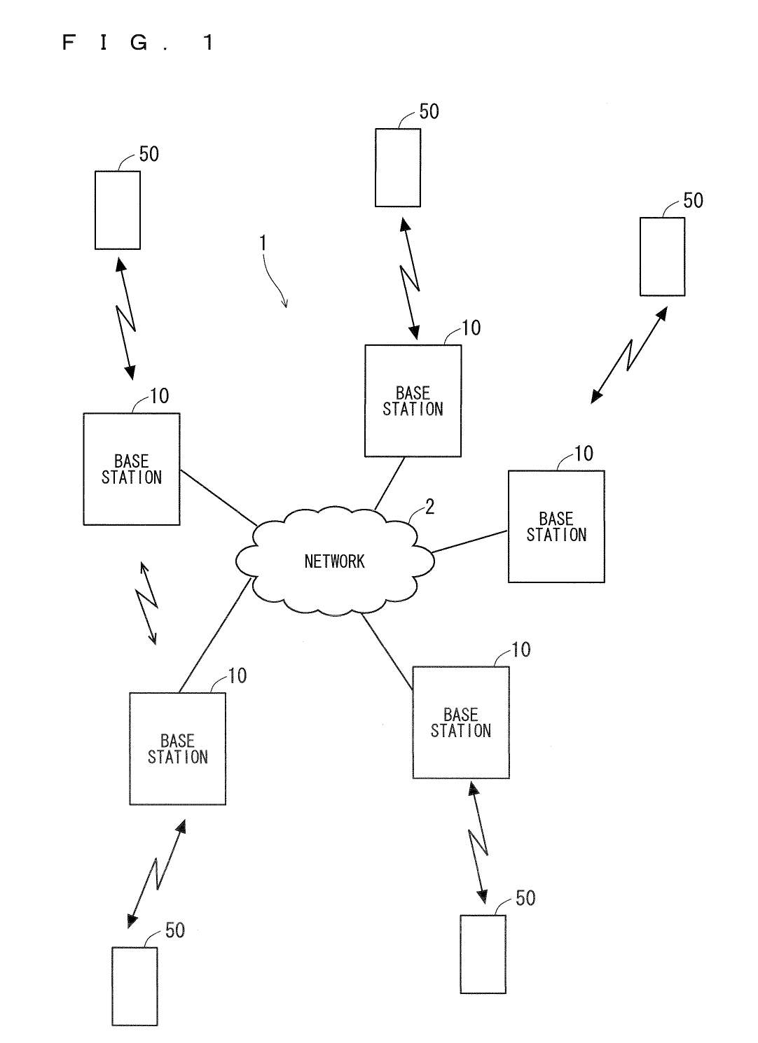

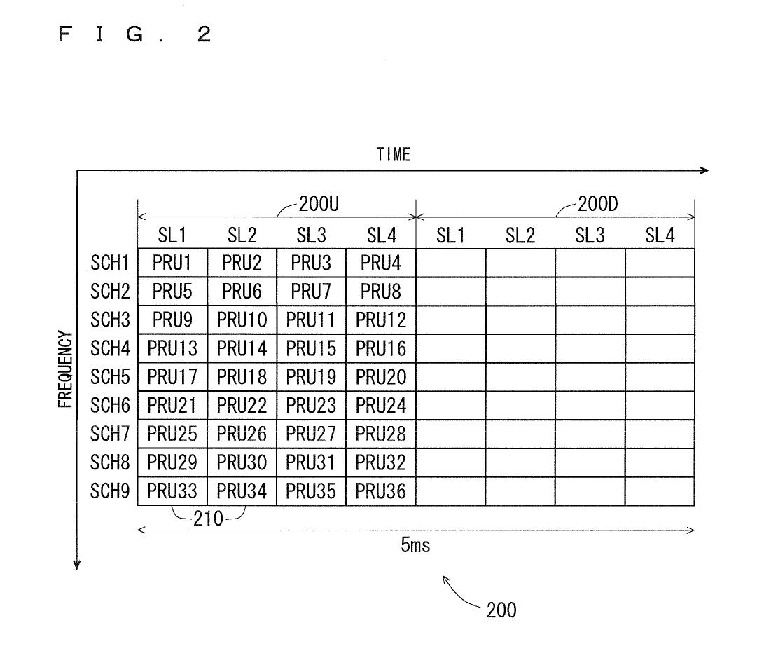

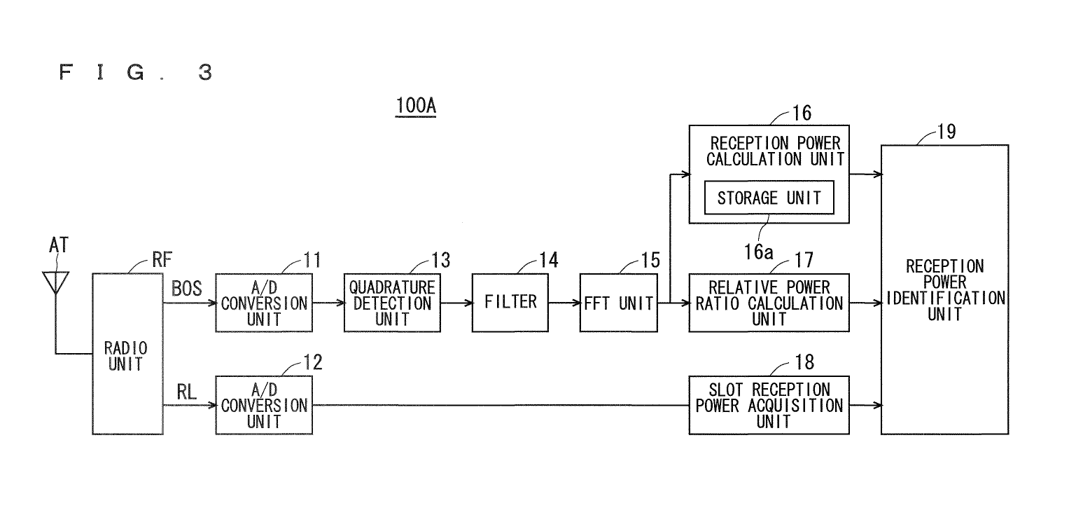

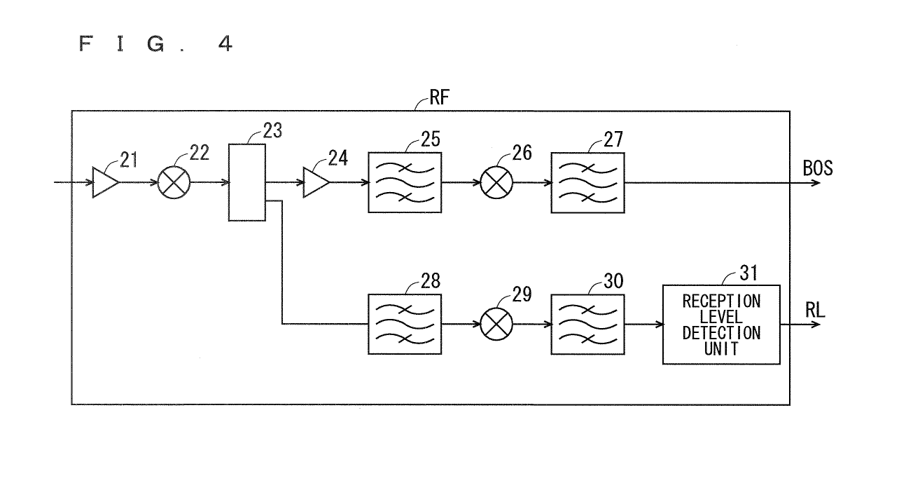

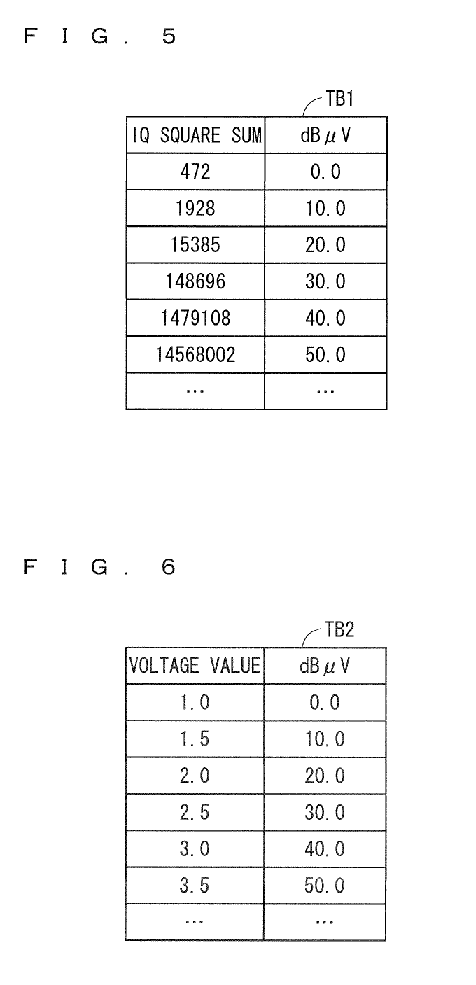

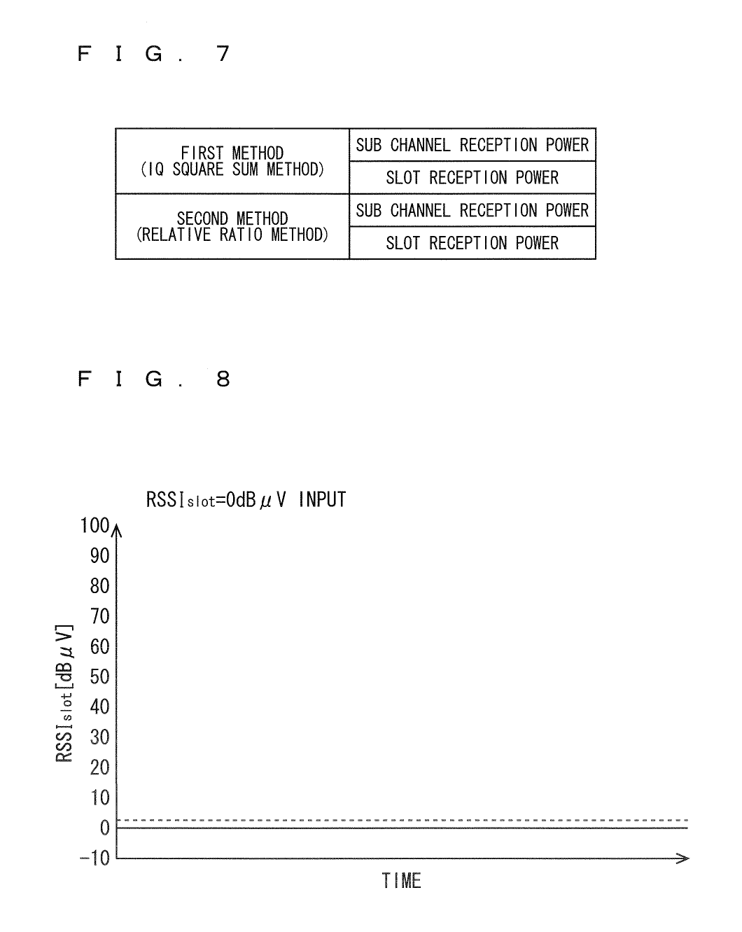

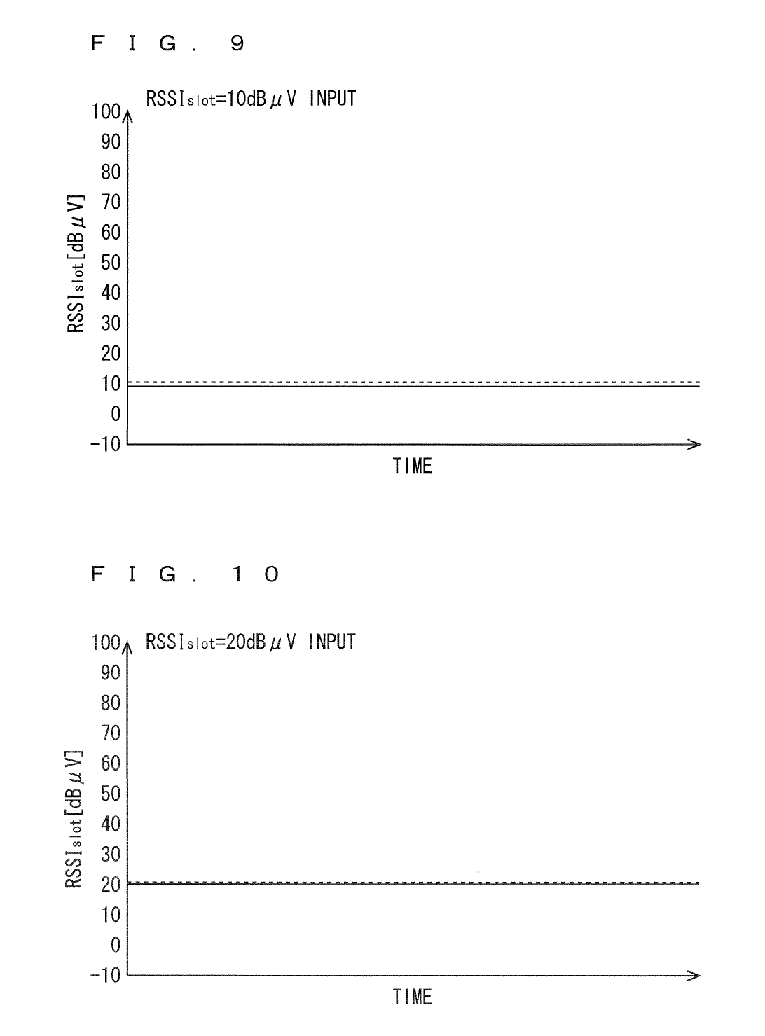

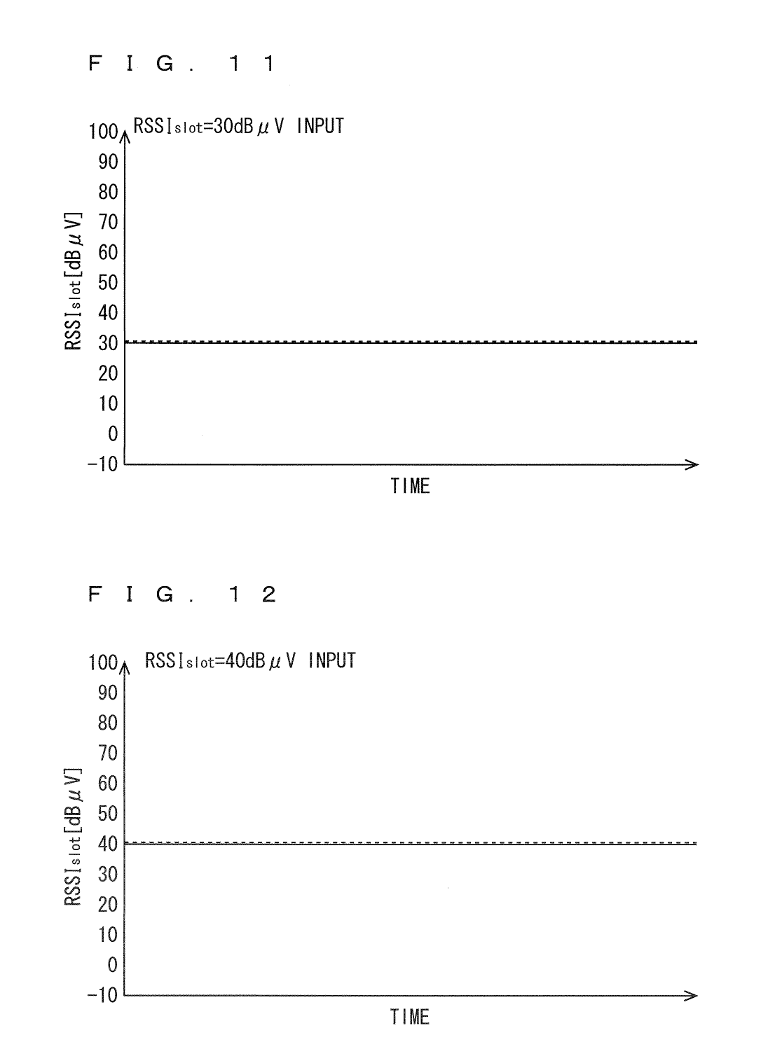

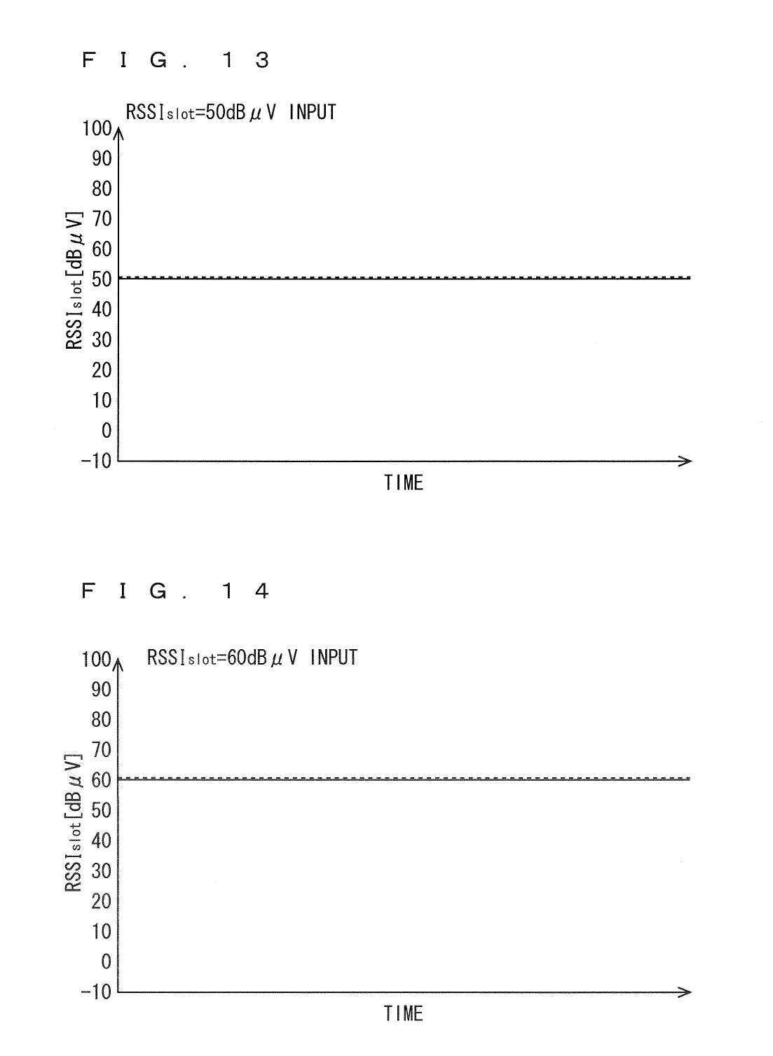

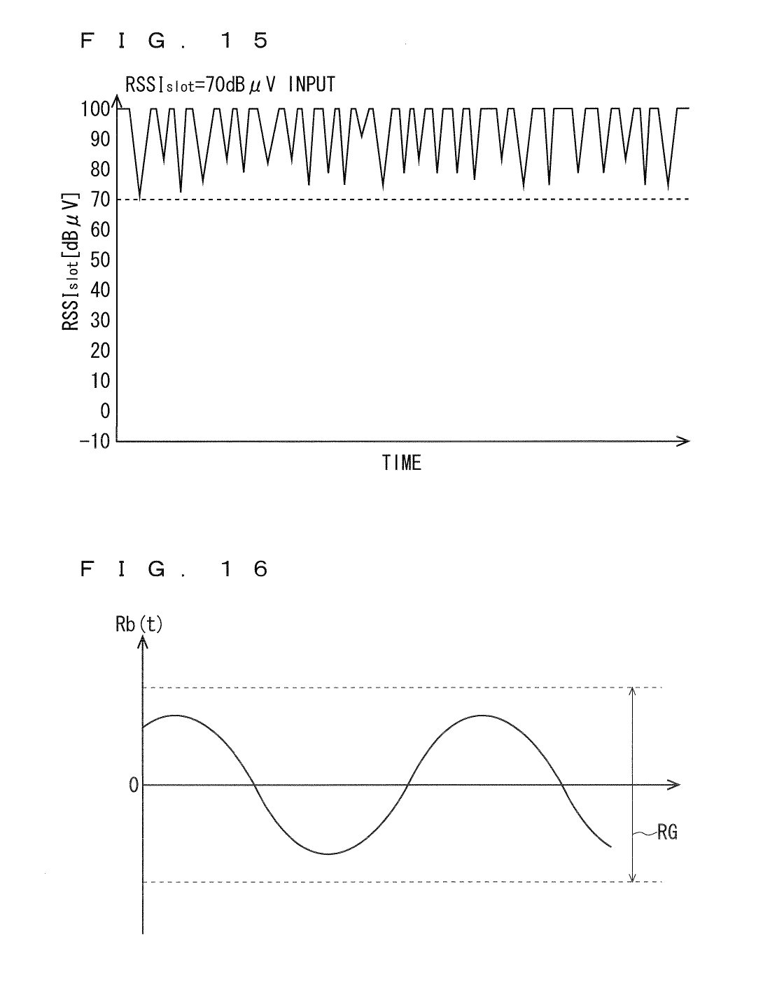

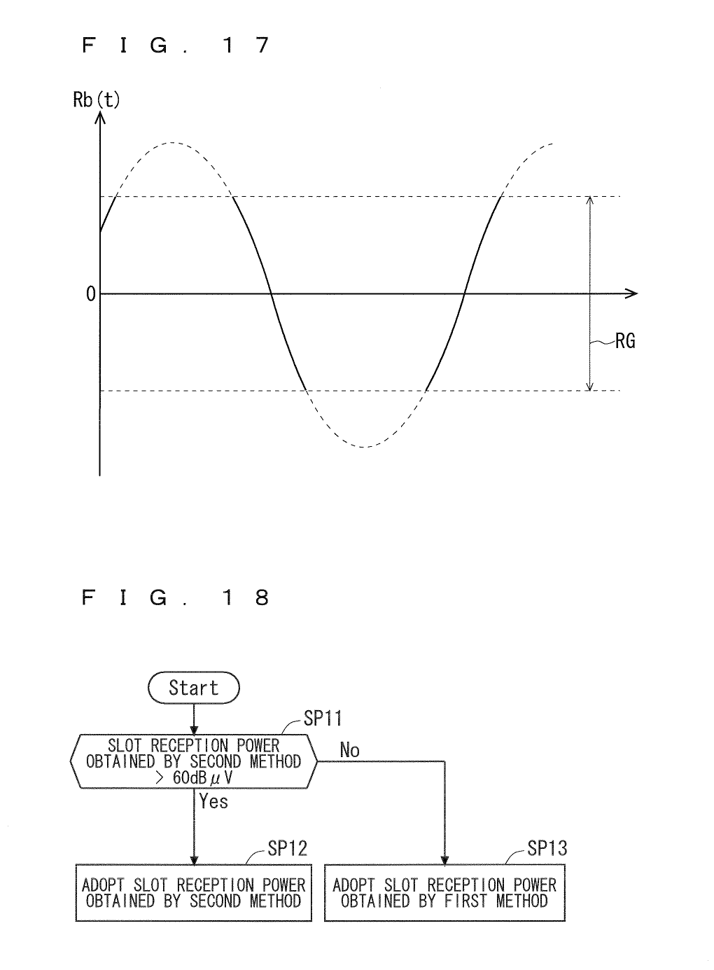

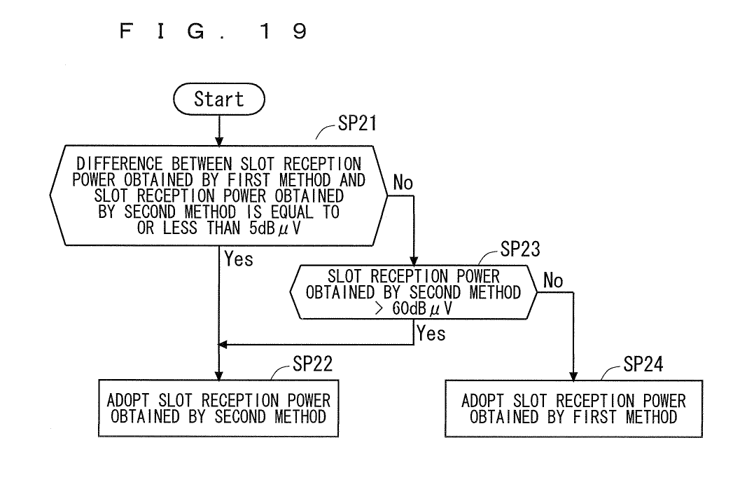

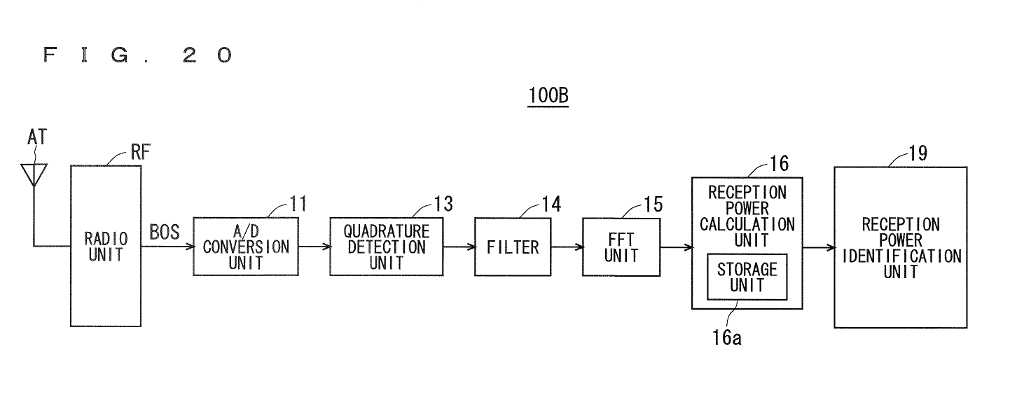

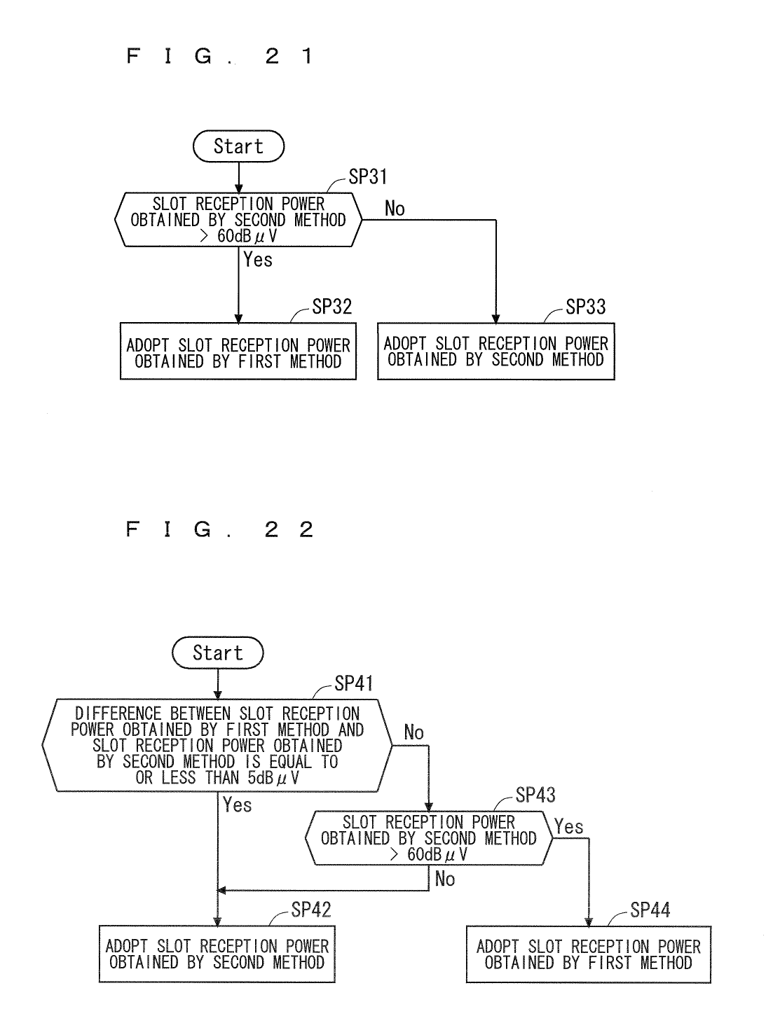

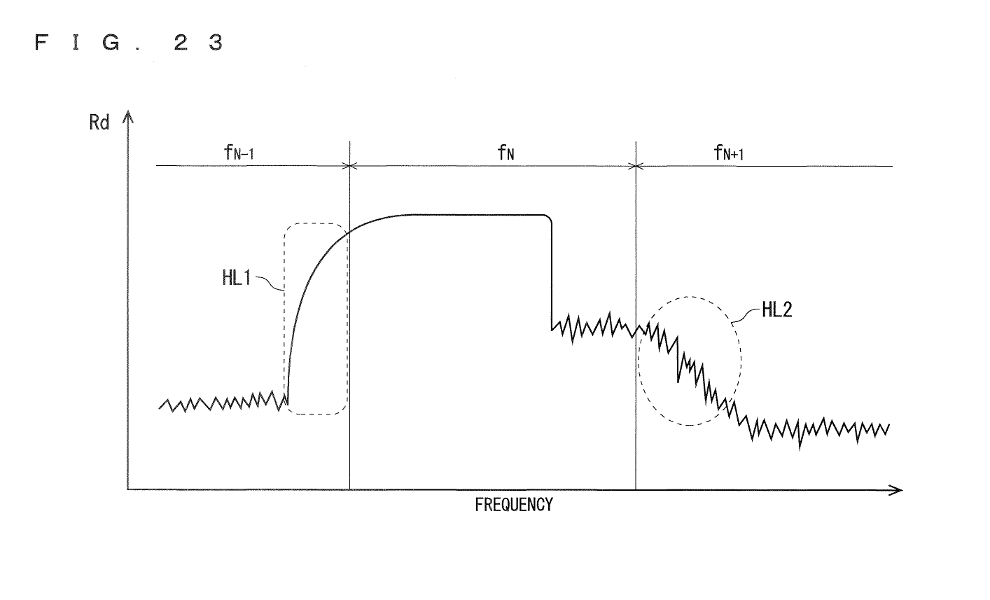

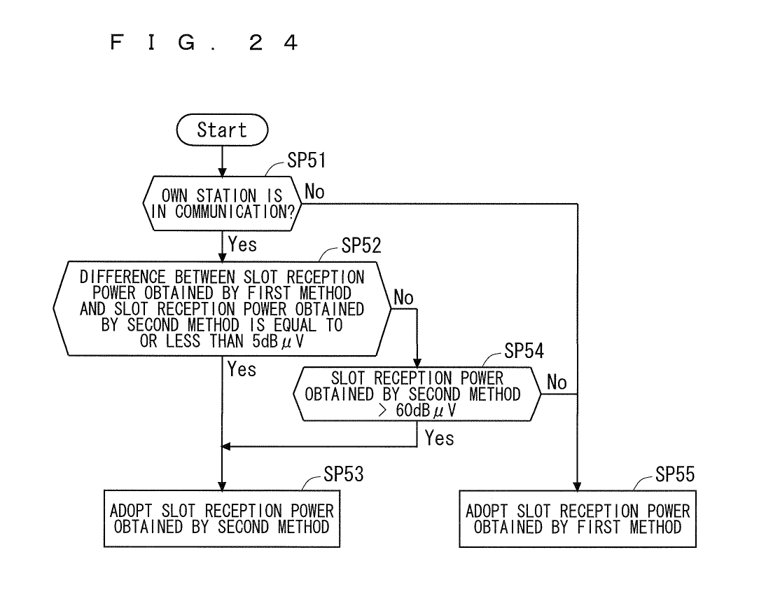

### BRIEF DESCRIPTION OF THE DRAWINGS

[FIG. 1] A diagram showing a configuration of a communication system according to an embodiment.

[FIG. 2] A diagram showing a configuration of a TDMA/TDD frame.

[FIG. 3] A block diagram showing a configuration of a communication apparatus according to the embodiment.

[FIG. 4] A diagram showing a detailed configuration of a radio unit.

[FIG. 5] A diagram showing a conversion table indicating the relationship between an IQ square sum and a reception power.

[FIG. 6] A diagram showing a conversion table indicating the relationship between a reception level and the reception power.

[FIG. 7] A diagram showing reception power types.

[FIG. 8] A diagram showing a slot reception power identified by a first method and a second method.

[FIG. 9] A diagram showing a slot reception power identified by the first method and the second method.

[FIG. 10] A diagram showing a slot reception power identified by the first method and the second method.

[FIG. 11] A diagram showing a slot reception power identified by the first method and the second method.

[FIG. 12] A diagram showing a slot reception power identified by the first method and the second method.

[FIG. 13] A diagram showing a slot reception power identified by the first method and the second method.

[FIG. 14] A diagram showing a slot reception power identified by the first method and the second method.

[FIG. 15] A diagram showing a slot reception power identified by the first method and the second method.

[FIG. 16] A diagram showing an analog signal inputted to an A/D conversion unit.

[FIG. 17] A diagram showing an analog signal inputted to the A/D conversion unit.

[FIG. 18] A flowchart showing a method for selecting the slot reception power.

[FIG. 19] A flowchart showing a method for selecting the slot reception power.

[FIG. 20] A block diagram showing a configuration of a communication apparatus according to a modification.

[FIG. 21] A flowchart showing a method for selecting the slot reception power according to the modification.

[FIG. 22] A flowchart showing a method for selecting the slot reception power according to the modification.

[FIG. 23] A diagram showing a down-converted signal.

[FIG. 24] A flowchart showing a method for selecting the slot reception power according to the modification.

### EMBODIMENT FOR CARRYING OUT THE INVENTION

### Embodiment

[Outline]

FIG. 1 is a diagram showing a configuration of a communication system 1 according to this embodiment. The communication system 1 is a communication system based on the XGP that is a normal standard of the next-generation PHS, and includes a plurality of base stations 10.

Each of the base stations 10 communicates with a communication terminal 50 in the TDMA/TDD scheme, and the base stations 10 are connected to one another via a network 2 serving as a backbone network. In the communication system 1 having this configuration, information transmission between communication terminals 50 remote from each other is achieved.

In the communication system 1, the OFDMA scheme is also adopted as a multiple access scheme. In the OFDMA scheme, an OFDM signal in which a plurality of orthogonal subcarriers are combined is used.

The communication between the base station 10 and the communication terminal 50 is performed by using a specific radio resource from wireless radio resources (also referred to as “wireless resource”). The wireless resource is identified on two dimensions having a time axis and a frequency axis, and includes a plurality of frames (also referred to as “TDMA/TDD frame”) 200. FIG. 2 is a diagram showing a configuration of the TDMA/TDD frame 200.

As shown in FIG. 2, the TDMA/TDD frame 200 is identified on a time-frequency plane with the horizontal axis and the vertical axis thereof representing time and frequency, respectively.

One TDMA/TDD frame 200 (unit TDMA/TDD frame) includes an upstream frame 200U for transmitting an upstream signal from the communication terminal 50 to the base station 10, and a downstream frame 200D for transmitting a downstream signal from the base station 10 to the communication terminal 50. Each of the upstream frame 200U and the downstream frame 200D is divided into four sections in the time direction, and includes a first slot SL1 to a fourth slot SL4. In the TDMA/TDD frame 200, the time width of one slot (unit slot) is set to be 625 μs, and each of the upstream frame 200U and the downstream frame 200D has a time length of 2.5 ms, and the unit TDMA/TDD frame has a time length of 5 ms.

Each of the slots SL1 to SL4 included in the upstream frame 200U will be also referred to as “upstream time slot”, and each of the slots SL1 to SL4 included in the downstream frame 200D will be also referred to as “downstream time slot”.

The TDMA/TDD frame 200 includes a first sub channel SCH1 to a j-th sub channel SCHj (j>1) in the frequency direction. In an aspect shown in FIG. 2, the first sub channel SCH1 to a ninth sub channel SCH9 is included. The bandwidth of one sub channel (unit sub channel) is 900 kHz, and one sub channel includes twenty-four subcarriers.

In the TDMA/TDD frame 200, one slot and one sub channel form one PRU (Physical Resource Unit) 210. The communication between the base station 10 and the communication terminal 50 is performed on a unit basis of this PRU 210. For example, in the base station 10, the allocation of the wireless resource to the communication terminal 50 is performed on a unit basis of the PRU 210, and a modulation scheme used for transmitting transmission data to the communication terminal 50 is determined for each PRU 210.

In each of the upstream frame 200U and the downstream frame 200D, four PRUs 210 are arranged along the time direction, and in the unit TDMA/TDD frame, eight PRUs 210 are arranged along the time direction. In the TDMA/TDD frame 200, nine PRUs 210, the number of which is equal the number of the sub channels, are arranged in the frequency direction.

For example, referring to FIG. 2, in the upstream frame 200U, unit numbers are sequentially assigned to the first sub channel SCH1 in the first slot SL1 to the ninth sub channel SCH9 in the fourth slot SL4. Thus, the upstream frame 200U is composed of thirty-six PRUs including the PRU1 through the PRU36. The PRUs 210 included in the downstream frame 200D are similarly assigned with unit numbers, though not shown in FIG. 2.

[Configuration of Communication Apparatus]

Here, a configuration of a communication apparatus 100A configured as the base station 10 will be described. FIG. 3 is a block diagram showing the configuration of the communication apparatus 100A. FIG. 4 is a diagram showing a detailed configuration of a radio unit RF. FIG. 5 is a diagram showing a conversion table TB1. FIG. 6 is a diagram showing a conversion table TB2. In FIG. 3, only a reception unit is shown, and a transmission unit is not shown.

As shown in FIG. 3, the communication apparatus 100A includes an array antenna AT, a radio unit RF, an A/D conversion units 11 and 12, a quadrature detection unit 13, a digital filter 14, an FFT unit 15, a reception power calculation unit 16, a relative power ratio calculation unit 17, a slot reception power acquisition unit 18, and a reception power identification unit 19. The communication apparatus 100A configured in this manner has a function for obtaining a reception power of a signal received by the array antenna AT.

More specifically, in the communication apparatus 100A, a reception signal received by the array antenna AT is inputted to the radio unit RF. Based on the inputted reception signal, the radio unit RF outputs an OFDM signal of a baseband (also referred to as “baseband OFDM signal”) BOS, and also outputs a signal level RL of the reception signal.

In more detail, as shown in FIG. 4, the radio unit RF includes amplifiers 21 and 24, mixers 22, 26, and 29, a signal separator 23, band pass filters 25, 27, 28, and 30, and a reception level detection unit 31.

The reception signal received by the array antenna AT is amplified by the amplifier 21, and then inputted to the mixer 22. The mixer 22 cooperates with a local oscillator, not shown, to function as a frequency band conversion unit for converting a frequency band of the signal into a lower frequency band (intermediate band).

An output signal from the mixer 22 is inputted to the signal separator 23. This output signal is separated into two paths by the signal separator 23. One output signal from the signal separator 23 is inputted to the amplifier 24, and the other output signal from the signal separator 23 is inputted to the band pass filter 28.

The signal amplified by the amplifier 24 is inputted to the band pass filter 25. The signal is subjected to a predetermined filtering process by the band pass filter 25, and then inputted to the mixer 26. The mixer 26 cooperates with a local oscillator, not shown, to function as a frequency band conversion unit for converting a frequency band of the signal into a lower frequency band (baseband). An output signal from the mixer 26 is inputted to the band pass filter 27. The band pass filter 27 removes an unnecessary signal other than the baseband signal from the output signal, and outputs the baseband signal (baseband OFDM signal) BOS.

On the other hand, the signal directly inputted from the signal separator 23 to the band pass filter 28, after going through the band pass filter 28, the mixer 29, and the band pass filter 30, is converted into a baseband signal and then inputted to the reception level detection unit 31.

The reception level detection unit 31 detects the signal level RL of the reception signal received by the array antenna AT. To be specific, the reception level detection unit 31 detects a voltage value of the reception signal in each of the slots SL1 to SL4 based on the reception signal in time domain received by the array antenna AT, and outputs the voltage value as the signal level RL of the reception signal.

In this manner, the radio unit RF outputs the baseband OFDM signal BOS and the signal level RL of the reception signal based on the reception signal. As the amplifiers 21 and 24 of the radio unit RF, fixed amplifiers having a constant amplification factor (gain) are used.

Returning to the description of the communication apparatus 100A (see FIG. 3), the baseband OFDM signal BOS and the signal level RL of the reception signal that are outputted from the radio unit RF are inputted to the A/D conversion units 11 and 12, respectively. The A/D conversion units 11 and 12 convert signals in analog form into signals in digital form, and output resulting signals.

The baseband OFDM signal in digital form outputted from the A/D conversion unit 11 is inputted to the quadrature detection unit 13. The quadrature detection unit 13 performs a quadrature detection on the baseband OFDM signal in the digital form, and generates an I (Inphase) component (in-phase component) and a Q (Quadrature) component (quadrature component) of the baseband OFDM signal. A signal of the I-component generated by the quadrature detection unit 13 is also referred as an in-phase signal, a signal of the Q-component is also referred to as a quadrature signal. The in-phase signal and the quadrature signal are also referred to as a complex OFDM signal.

The in-phase signal and the quadrature signal of the baseband OFDM signal are subjected to a filtering process by the digital filter 14, and then inputted to the FFT unit 15.

The FFT unit 15 performs a fast Fourier transformation (FFT: Fast Fourier Transform) on the in-phase signal and the quadrature signal inputted thereto. Thereby, the FFT unit 15 outputs an in-phase signal and a quadrature signal of a complex symbol with respect to each of the plurality of subcarriers included in the baseband OFDM signal. The in-phase signal and the quadrature signal of the complex symbol with respect to each subcarrier, outputted from the FFT unit 15, are inputted to the reception power calculation unit 16 and the relative power ratio calculation unit 17.

In the reception power calculation unit 16, a reception power (also referred to as “sub channel reception power”) of each sub channel is obtained based on the in-phase signal and the quadrature signal of the complex symbol with respect to each subcarrier. For example, to obtain a reception power of a certain sub channel in one slot, the reception power calculation unit 16 calculates the sum of squares (also referred to as “IQ square sum”) of the in-phase signal and the quadrature signal with respect to each of some subcarriers included in this sub channel. Then, in the reception power calculation unit 16, the average value of a plurality of the IQ square sums thus calculated is used as the IQ square sum (sub-channel IQ square sum) of this sub channel, and the reception power of this sub channel is obtained based on this IQ square sum. The reception power calculation unit 16 includes a storage unit 16a for storing the conversion table TB1 shown in FIG. 5. The obtaining of the sub channel reception power is implemented by referring to the conversion table TB1 and identifying a sub channel reception power corresponding to the sub-channel IQ square sum. Here, the IQ square sum of a subcarrier is represented as a result obtained by squaring each of the in-phase signal and the quadrature signal of the subcarrier and summing the squared in-phase and quadrature signals.

In the reception power calculation unit 16, the sum of sub-channel IQ square sums of the sub channels included in one slot is calculated and, based on the calculated sum, the reception power (also referred to as “slot reception power”) of this one slot is obtained. The obtaining of the slot reception power based on the sum is implemented by referring to the conversion table TB1 shown in FIG. 5.

In this manner, in the reception power calculation unit 16, the sub channel reception power of each sub channel is obtained, and each sub channel reception power is outputted to the reception power identification unit 19. Also, in the reception power calculation unit 16, the slot reception power of each slot is obtained, and each slot reception power is outputted to the reception power identification unit 19.

The relationship between the IQ square sum and the reception power shown in conversion table TB1 can be identified by generating a signal having a known reception power and measuring, with a predetermined measuring instrument, the IQ square sum obtained from the communication apparatus 100A as a result of inputting the generated signal to the communication apparatus 100A. In preparation of the conversion table TB1, for example, when a signal having a reception power of 10.0 dB μV was inputted to the communication apparatus 100A, the IQ square sum obtained from the communication apparatus 100A was “1928”. The correspondence relationship between the IQ square sum and the reception power that has been identified in this manner is preliminarily stored, as the conversion table TB1, in the storage unit 16a of the reception power calculation unit 16. The reception power is also referred to as a reception signal strength (RSSI: Reception Signal Strength Indication).

In the relative power ratio calculation unit 17, a relative ratio (also referred to as “relative reception power ratio” or “relative power ratio”) of the reception power of each sub channel is calculated based on the in-phase signal and the quadrature signal of the complex symbol with respect to each of the subcarriers. More specifically, in the same manner as the reception power calculation unit 16, the relative power ratio calculation unit 17 calculates the sub-channel IQ square sum of each of the sub channels included in one slot. Then, the relative power ratio calculation unit 17 sums the sub-channel IQ square sums, thus calculating the sum of the IQ square sums of all the sub channels. Then, moreover, the relative power ratio calculation unit 17 divides the sub-channel IQ square sum of a certain sub channel by the sum of the IQ square sums of all the sub channels, thereby obtaining a relative power ratio of the certain sub channel to all the sub channels in one slot. That is, when the sub-channel IQ square sum of the j-th sub channel is defined as “IQₛᵤₘ(j)”, the relative power ratio Re(n) of a n-th sub channel in a specific slot is represented by the expression (1).

$$\begin{matrix}[ Math . 1 ] & \\ Re ( n ) = \frac{{IQ}_{sum} ( n )}{{\sum }_{j = 1} {IQ}_{sum} ( j )} & ( 1 )\end{matrix}$$

This calculation of the relative power ratio is performed for each of the sub channels included in each slot. The relative power ratios thus calculated are outputted to the reception power identification unit 19.

On the other hand, the signal level of the reception signal in digital form outputted from the A/D conversion unit 12 is inputted to the slot reception power acquisition unit 18. The slot reception power acquisition unit 18 refers to a conversion table TB2 shown in FIG. 6, and thereby obtains a slot reception power of each of the slots SL1 to SL4 that corresponds to the signal level (voltage value) of the reception signal of each of the slots SL1 to SL4. Each slot reception power obtained by the slot reception power acquisition unit 18 is outputted to the reception power identification unit 19. The conversion table TB2 shows conversion of the reception level expressed in the voltage value into the reception signal strength (RSSI) in dB, and the slot reception power obtained by the slot reception power acquisition unit 18 is expressed as a value in dB.

The reception power identification unit 19 identifies various reception powers based on input values from the reception power calculation unit 16, the relative power ratio calculation unit 17, and the slot reception power acquisition unit 18. Types of the identified reception powers include the sub channel reception power on a sub channel basis and the slot reception power on a slot basis. Each of the reception powers is calculated in two kinds of methods. FIG. 7 is a diagram showing reception power types.

To be specific, as shown in FIG. 7, the reception power identification unit 19 identifies the sub channel reception power inputted from the reception power calculation unit 16 as a sub channel reception power identified (calculated) by a first method (IQ square sum method). The reception power identification unit 19 identifies the slot reception power inputted from the reception power calculation unit 16 as a slot reception power identified by the IQ square sum method.

The reception power identification unit 19 identifies the slot reception power inputted from the slot reception power acquisition unit 18 as a slot reception power identified by a second method (relative ratio method). The reception power identification unit 19 calculates a sub channel reception power based on the relative power ratio inputted from the relative power ratio calculation unit 17 and the slot reception power inputted from the slot reception power acquisition unit 18, and identifies the calculated sub channel reception power as a sub channel reception power identified by the second method.

The sub channel reception power obtained by the second method is calculated using the following expression (2). That is, when the slot reception power inputted from the slot reception power acquisition unit 18 is defined as “RSSIₛₗₒₜ” and the relative power ratio of the n-th sub channel inputted from the relative power ratio calculation unit 17 is defined as “Re(n)”, the sub channel reception power RSSI_{sub}(n) of the n-th sub channel in one slot is represented by the expression (2).

[Math. 2]

RSSI_{sub}(n)=RSSIₛₗₒₜ×10 log₁₀Re(n) (2)

In this manner, the reception power identification unit 19 can obtain not only the slot reception power and the sub channel reception power identified by the first method, but also the slot reception power and the sub channel reception power identified by the second method. Devices for calculating the slot reception power in the second method, namely, the reception level detection unit 31, the A/D converter 12, and the slot reception power acquisition unit 18, are configured as special devices.

[Comparison between First Method and Second Method]

Next, a difference between the first method and the second method for the reception power will be described. FIGS. 8 to 15 are diagrams showing the slot reception powers RSSIₛₗₒₜ that were identified by the first method and the second method when signals having known reception signal strengths were inputted to the communication apparatus 100A. In FIGS. 8 to 15, the slot reception power identified by the first method is indicated by the solid line, and the slot reception power identified by the second method is indicated by the wavy line.

As shown in FIG. 8, when the signal having a slot reception power of 0 dB μV was inputted to the communication apparatus 100A, the accuracy of identification of the slot reception power was higher in the first method than in the second method. In a case of 10 dB μV to 60 dB μV, as shown in FIGS. 9 to 14, the slot reception power obtained by the first method and the slot reception power obtained by the second method were substantially equal to each other, and there was no difference in the accuracy of identification of the slot reception power between the first method and the second method.

The decrease in the accuracy of identification of the slot reception power by the second method in a case of 0 dB μV is due to characteristics of the special device. More specifically, there is a limit to a safe operating range of the special device and thus, depending on the reception signal strength, an output of the special device may include a measurement error. Therefore, by the second method in which the reception power is obtained using the output of the special device, the accuracy of identification of the reception power is deteriorated with respect to a signal having a relatively low electric field strength.

On the other hand, as shown in FIG. 15, when the signal having a slot reception power of 70 dB μV was inputted to the communication apparatus 100A, it was difficult to identify the slot reception power by the first method.

This difficulty in identification of the slot reception power by the first method in a case of 70 dB μV is due to an excessive increase in the magnitude of the baseband OFDM signal BOS outputted from the radio unit RF, which makes it impossible for the A/D conversion unit 11 to obtain a suitable signal value in digital form. FIGS. 16 and 17 are diagrams showing the analog signal inputted to the A/D conversion unit 11.

More specifically, in the A/D conversion unit 11, there is a limit to the width of a digital signal that can be expressed for the inputted analog signal. Therefore, if an analog signal having a value higher than a value that can be expressed as a digital signal value is inputted, the A/D conversion unit 11 cannot correctly express the analog signal, and the outputted digital signal is saturated. In the radio unit RF of this embodiment, since fixed amplifiers are adopted as the amplifiers 21 and 24, whether or not an output value of the A/D conversion unit 11 is saturated is proportional to the strength of the received signal (the electric field strength of the reception signal).

For example, in a case where a signal having a low electric field strength (for example, the slot reception power=40 dB μV) is received, as shown in FIG. 16, an analog signal Rb(t) inputted to the A/D conversion unit 11 becomes, in the A/D conversion unit 11, a signal falling within a range RG that allows expression as the digital signal value. On the other hand, a signal having a high electric field strength (for example, the slot reception power=70 dB μV) is received, as shown in FIG. 17, the analog signal Rb(t) inputted to the A/D conversion unit 11 becomes, in the A/D conversion unit 11, a signal partially outside the range RG that allows expression as the digital signal value. In this case, the digital signal outputted from the A/D conversion unit 11 includes a saturated signal. This makes it impossible for the reception power calculation unit 16 in the subsequent stage to obtain a correct IQ square sum, thus making it difficult to identify the slot reception power by the first method.

In this manner, the accuracy of identification of the slot reception power by the first method and the accuracy of identification of the slot reception power by the second method vary in accordance with the reception signal strength. Therefore, it is preferable that the slot reception power identified by the method having a higher accuracy of identification is adopted as a current slot reception power.

The reception power identification unit 19 of this embodiment also has a function as a selection unit for selecting, in an alternative manner, which of the slot reception power identified by the first method and the slot reception power identified by the second method should be used as the current slot reception power. FIGS. 18 and 19 are flowcharts for selecting which of the slot reception power identified by the first method and the slot reception power identified by the second method should be adopted as the current slot reception power.

For example, in the flowchart shown in FIG. 18, in step SP11, whether or not the slot reception power identified by the second method is higher than a predetermined value is determined. This predetermined value indicates a specific slot reception power in such a range that the A/D-converted output signal from the A/D conversion unit 11 is not saturated, and is determined based on whether or not an A/D-converted output signal is saturated when a signal having this specific slot reception power is inputted as the reception signal to the communication apparatus 100A. It is preferable that a value immediately before the signal is saturated is adopted as the predetermined value, and herein, 60 dB μV is adopted as the predetermined value.

If, in step SP11, it is determine that the slot reception power obtained by the second method is higher than the predetermined value, an operation flow moves to step SP12, in which the slot reception power identified by the second method is adopted as the current slot reception power. On the other hand, if the slot reception power obtained by the second method is equal to or lower than the predetermined value, the operation flow moves to step SP13, in which the slot reception power identified by the first method is adopted as the current slot reception power.

For example, in an aspect shown in the flowchart of FIG. 19, the slot reception power identified by the second method is mainly used as the current slot reception power. To be specific, in step SP21, whether or not a difference between the slot reception power identified by the first method and the slot reception power identified by the second method is equal to or less than a first threshold value is determined. For example, 5 dB μV may be adopted as the first threshold value.

If, in step SP21, a difference value between both methods is equal to or less than the first threshold value, an operation flow moves to step SP22, in which the slot reception power identified by the second method is adopted as the current slot reception power. On the other hand, if the difference value between both methods is more than the first threshold value, the operation flow moves to step SP23.

In step SP23, whether or not the slot reception power identified by the second method is more than a second threshold value is determined. It is preferable that a limit value immediately before the digital signal is saturated is adopted as the second threshold value, and herein, 60 dB μV is adopted as the second threshold value.

If, in step SP23, it is determined that the slot reception power obtained by the second method is more than the second threshold value, the operation flow moves to step SP22, in which the slot reception power identified by the second method is adopted as the current slot reception power. On the other hand, if the slot reception power obtained by the second method is equal to or less than the second threshold value, the operation flow moves to step SP24, in which the slot reception power identified by the first method is adopted as the current slot reception power.

In this manner, which of the slot reception powers identified by both methods should be adopted as the current slot reception power is determined based on the limit value immediately before the digital signal is saturated, and thereby the slot reception power identified by the best method in accordance with the reception signal strength can be used as the current slot reception power. The flowcharts shown in FIGS. 18 and 19 are merely illustrative, and the current slot reception power may be determined in accordance with another flowchart.

As described above, the communication apparatus 100A includes the quadrature detection unit 13, the FFT unit 15, and the reception power calculation unit 16. The quadrature detection unit 13 performs the quadrature detection on the baseband OFDM signal and generates the complex OFDM signal. The FFT unit 15 performs a Fourier transform process on the complex OFDM signal and outputs a complex symbol with respect to each of the subcarriers. The reception power calculation unit 16 obtains the reception power of the reception signal based on the sum of squares of the in-phase signal and the quadrature signal of the complex symbol of the subcarrier outputted from the FFT unit 15. The reception power calculation unit 16 includes the storage unit for storing the correspondence relationship between the reception power and the sum of squares of the in-phase signal and the quadrature signal of the complex symbol. The reception power calculation unit 16 obtains the reception power of the reception signal by using the correspondence relationship. The communication apparatus 100A having such a configuration enables the reception power to be accurately measured.

<Modification>

Although an embodiment of the present invention has been described above, the present invention is not limited to the above-described ones.

For example, in the embodiment described above, the slot reception power can be identified by the first method and by the second method, but this is not limitative. FIG. 20 is a block diagram showing a configuration of a communication apparatus 100B according to a modification. In the communication apparatus 100B, the parts in common with the communication apparatus 100A are denoted by the same reference numerals, and descriptions thereof are omitted.

More specifically, in a possible aspect, as shown in FIG. 20, the communication apparatus 100B has only the configuration for identifying the slot reception power by the first method. Thereby, in a case of receiving a signal having a low electric field strength, the slot reception power of the reception signal can be accurately identified. Additionally, since the communication apparatus 100B does not have the configuration for identifying the slot reception power by the second method, a cost reduction is achieved.

In the embodiment described above, in a case where a signal of a communication partner is weak, that is, in a case where a signal having a low electric field strength is received, the slot reception power identified by the first method is used as the current slot reception power, while in a case where a signal of a communication partner is strong, that is, in a case where a signal having a high electric field strength is received, the slot reception power identified by the second method is used as the current slot reception power. However, this is not limiting.

More specifically, a case is assumed where the special device for identifying the slot reception power by the second method has such characteristics that the slot reception power of a signal having a low electric field strength can be accurately identified while the slot reception power of a signal having a high electric field strength cannot be accurately identified. In this case, preferably, if the amplification factor of the fixed amplifier is designed such that the output value from the A/D conversion unit 11 is not saturated even when a signal having a high electric field strength is received, the slot reception power identified by the second method is used as the current slot reception power in a case of receiving a signal having a low electric field strength while the slot reception power identified by the first method is used as the current slot reception power in a case of receiving a signal having a high electric field strength.

In this modification, the flowcharts of FIGS. 18 and 19 are modified into those of FIGS. 21 and 22, respectively. In the flowchart of FIG. 21, in step SP31, whether or not the slot reception power identified by the second method is higher than the predetermined value (for example, 60 dB μV) is determined.

If, in step SP31, it is determined that the slot reception power obtained by the second method is higher than the predetermined value, an operation flow moves to step SP32, in which the slot reception power identified by the first method is adopted as the current slot reception power. On the other hand, if the slot reception power obtained by the second method is equal to or lower than the predetermined value, the operation flow moves to step SP33, in which the slot reception power identified by the second method is adopted as the current slot reception power.

For example, in the flowchart of FIG. 22, in step SP41, whether or not a difference between the slot reception power identified by the first method and the slot reception power identified by the second method is equal to or less than the first threshold value (for example, 5 dB μV) is determined.

If, in step SP41, a difference value between both methods is equal to or less than the first threshold value, the operation flow moves to step SP42, in which the slot reception power identified by the second method is adopted as the current slot reception power. On the other hand, if the difference value between both methods is more than the first threshold value, the operation flow moves to step SP43.

In step SP43, whether or not the slot reception power identified by the second method is higher than the second threshold value (for example, 60 dB μV) is determined.

If, in step SP43, it is determined that the slot reception power obtained by the second method is higher than the second threshold value, the operation flow moves to step SP44, in which the slot reception power identified by the first method is adopted as the current slot reception power. On the other hand, if the slot reception power obtained by the second method is equal to or lower than the second threshold value, the operation flow moves to step SP42, in which the slot reception power identified by the second method is adopted as the current slot reception power.

In the embodiment described above, the reception power is measured in consideration of one specific frequency band used for communication. However, this is not limiting, and the reception power may be measured in consideration of a plurality of different frequency bands used for communication. FIG. 23 is a diagram showing a down-converted signal Rd having passed through the band pass filter 30. FIG. 24 is a flowchart showing a method for selecting the reception power.

To be specific, in the communication system 1, a plurality of different frequency bands may be used for communication, and in this case, a frequency band to be used is allocated to each base station. For example, in a case where a frequency band “f_{N}” is used in a certain base station, a frequency band “f_{N-1}” or a frequency band “f_{N+1}” adjacent to the frequency band “f_{N}” is used in another base station.

In each base station (communication apparatus), the band pass filters 28 and 30 are provided for removing a signal of an unnecessary frequency band at the time of down-conversion. However, the band pass filters 28 and 29, due to their characteristics, cannot rapidly remove an unnecessary frequency.

Therefore, in a situation where different frequency bands are allocated to different base stations and a surrounding base station that uses a different frequency band for communication is in a communicating state, a possibility arises that a signal of a frequency band unnecessary for a base station may be used as a signal of a frequency band effective for the base station. For example, in a case where surrounding base stations located in the surroundings of a certain base station that uses the frequency band “f_{N}” use the frequency band “f_{N-1}” and the frequency band “f_{N+1}”, the signal “Rd” having passed the band pass filter 30 includes, as shown in FIG. 23, a signal of the frequency band f_{N-1} in a range enclosed by the broken line HL1 and a signal of the frequency band f_{N+1} in a range enclosed by the broken line HL2.

Here, in the special device provided in the base station, the slot reception power is identified based on the signal “Rd” having passed through the band pass filter 30. Accordingly, if the signal “Rd” having passed through the band pass filter 30 includes the signals of the unnecessary frequency bands f_{N-1} and f_{N+1} in the ranges enclosed by the broken lines HL1 and HL2, the special device measures the slot reception power under a condition that the signals of the unnecessary frequency bands out of the effective band in the ranges enclosed by the broken lines HL1 and HL2 are involved. As a result, the accuracy of measurement of the slot reception power by the second method using the special device is deteriorated.

On the other hand, in the first method, a signal of an unnecessary frequency band out of the effective band is not involved in the identification of the slot reception power. Therefore, even in a case where a plurality of frequency bands are used for communication, the accuracy of measurement of the slot reception power by the first method is not deteriorated.

Thus, in the communication system 1, in a case where a plurality of frequency bands are used for communication, the first method is more likely to accurately identify the slot reception power than the second method, and it would be preferable to identify the reception power by using the first method rather than the second method.

In this modification, the flowchart of FIG. 19 may be modified into, for example, a flowchart of FIG. 24.

More specifically, in step SP51, whether or not an own station is in communication is determined. If the own station is not in communication, it is considered that all the measured reception powers are powers of the adjacent frequency bands (adjacent bands). At this time, if the slot reception power is identified by the second method using the special device, the reception powers of the adjacent bands are involved. Therefore, if the own station is not in communication, an operation flow moves to step SP55, in which the slot reception power identified by the first method is adopted as the current slot reception power.

On the other hand, if the own station is in communication, the distance between the own station and a communication partner of the own station is short, so that the reception power of the signal of the frequency band of the own station is relatively higher than the reception power of the signal of the adjacent band, and therefore an influence of the signal of the adjacent band is small. Thus, the operation flow moves to step SP52, in which the selection of the reception power identification method is continuously performed.

In step SP52, whether or not a difference between the slot reception power identified by the first method and the slot reception power identified by the second method is equal to or less than the first threshold value is determined. For example, 5 dB μV may be adopted as the first threshold value.

If, in step SP52, a difference value between both methods is equal to or less than the first threshold value, the operation flow moves to step SP53, in which the slot reception power identified by the second method is adopted as the current slot reception power. On the other hand, the difference value between both methods is more than the first threshold value, the operation flow moves to step SP54.

In step SP54, whether or not the slot reception power identified by the second method is higher than the second threshold value is determined. It is preferable that a limit value immediately before the digital signal is saturated is adopted as the second threshold value, and herein, 60 dB μV is adopted as the second threshold value.

If, in step SP54, it is determined that the slot reception power obtained by the second method is higher than the second threshold value, the operation flow moves to step SP53, in which the slot reception power identified by the second method is adopted as the current slot reception power. On the other hand, if the slot reception power obtained by the second method is equal to or lower than the second threshold value, the operation flow moves to step SP55, in which the slot reception power identified by the first method is adopted as the current slot reception power.

In this manner, in the communication system 1, in a case where a plurality of different frequency bands are used for communication, which of the slot reception powers identified by the first method and the second method should be adopted as the current slot reception power is determined also based on whether or not the own station is in communication, and thereby the slot reception power identified by the best method can be used as the current slot reception power.

In the embodiment and the modification described above, a case where the communication apparatus 100A, 100B is the base station 10 has been described. However, this is not limiting, and the communication apparatus 100A, 100B may be the communication terminal 50.

In the embodiment and the modifications described above, a case where the present invention is applied to the next-generation PHS has been described. However, the present invention is applicable to other communication systems. For example, the

1. A communication apparatus comprising:
a quadrature detection unit for performing a quadrature detection on a reception signal that is an OFDM signal and generating a complex OFDM signal;
a Fourier transform unit for performing a Fourier transform process on the complex OFDM signal and outputting a complex symbol with respect to each subcarrier; and
a reception power acquisition unit for obtaining a reception power of the reception signal based on a sum of squares of an in-phase signal and a quadrature signal of the complex symbol of the subcarrier outputted from the Fourier transform unit,
wherein the reception power acquisition unit includes a storage unit for storing a correspondence relationship between a reception power and a sum of squares of an in-phase signal and a quadrature signal of a complex symbol, and obtains the reception power of the reception signal by using the correspondence relationship.

2. The communication apparatus according to claim 1, wherein
the reception power acquisition unit obtains, on a slot basis, a first slot reception power of the reception signal based on the sum of squares of the in-phase signal and the quadrature signal of the complex symbol of the subcarrier outputted from the Fourier transform unit,
the communication apparatus further comprises:
a detection unit for detecting a signal level of the reception signal based on the reception signal in a time domain;
a slot reception power acquisition unit for obtaining, on a slot basis, a second slot reception power of the reception signal based on the signal level of the reception signal; and
a selection unit for selecting, in an alternative manner, either one of the first slot reception power and the second slot reception power as a slot reception power of the reception signal.

3. The communication apparatus according to claim 2, wherein
the correspondence relationship is obtained in advance by measuring a sum of squares of an in-phase signal and a quadrature signal of a subcarrier outputted from the Fourier transform unit as a result of inputting a signal having a known reception power to the communication apparatus.

4. The communication apparatus according to claim 3, wherein
the correspondence relationship is, in the form of a table, stored in the storage unit.

5. The communication apparatus according to claim 2, further comprising an A/D conversion unit for converting a signal in analog form into a signal in digital form, wherein
the complex OFDM signal inputted to the Fourier transform unit is a signal in the digital form,
the selection unit selects, in an alternative manner, either one of the first slot reception power and the second slot reception power as the slot reception power of the reception signal, in accordance with a result of comparison between the second slot reception power and a predetermined value,
the predetermined value is a slot reception power in such a range that an output signal of the A/D conversion unit is not saturated.

6. The communication apparatus according to claim 5, wherein
in a case where the second slot reception power is higher than the predetermined value, the selection unit selects the second slot reception power as the slot reception power of the reception signal.

7. The communication apparatus according to claim 5, wherein
in a case where the second slot reception power is equal to or lower than the predetermined value, the selection unit selects the first slot reception power as the slot reception power of the reception signal.

8. The communication apparatus according to claim 6, wherein
in a case where the second slot reception power is equal to or lower than the predetermined value, the selection unit selects the first slot reception power as the slot reception power of the reception signal.

9. The communication apparatus according to claim 4, wherein
based on the sum of squares of the in-phase signal and the quadrature signal of the complex symbol of the subcarrier outputted from the Fourier transform unit, the reception power acquisition unit obtains a reception power of a sub channel including said subcarrier.

10. The communication apparatus according to claim 7, wherein
based on the sum of squares of the in-phase signal and the quadrature signal of the complex symbol of the subcarrier outputted from the Fourier transform unit, the reception power acquisition unit obtains a reception power of a sub channel including said subcarrier.

11. The communication apparatus according to claim 8, wherein
based on the sum of squares of the in-phase signal and the quadrature signal of the complex symbol of the subcarrier outputted from the Fourier transform unit, the reception power acquisition unit obtains a reception power of a sub channel including said subcarrier.

12. A reception power measuring method comprising the steps of:
a) performing a quadrature detection on a reception signal that is an OFDM signal and generating a complex OFDM signal;
b) performing a Fourier transform process on the complex OFDM signal and outputting a complex symbol with respect to each subcarrier; and
c) obtaining a reception power of the reception signal based on a sum of squares of an in-phase signal and a quadrature signal of a complex symbol of the subcarrier,
wherein, in the step c), the reception power of the reception signal is obtained by using a correspondence relationship between a reception power and the sum of squares of an in-phase signal and a quadrature signal of a complex symbol, the correspondence relationship being stored in advance.
